(19) United States
(12) Patent Application Publication
(10) Pub. No.: US 2025/0354806 A1
(43) Pub. Date: Nov. 20, 2025

(54) OVAL-SCANNING AIRBORNE LIGHT DETECTION AND RANGING (LIDAR) BATHYMETRY SYSTEM WITH CONTROLLABLE SCANNING DIRECTION AND POSITIONING METHOD USING THE SAME

(71) Applicant: Guilin University of Technology, Guilin (CN)

(72) Inventors: Guoqing ZHOU, Guilin (CN); Guofu QIN, Guilin (CN); Gang LIANG, Guilin (CN)

(21) Appl. No.: 19/283,121

(22) Filed: Jul. 28, 2025

(30) Foreign Application Priority Data
Dec. 3, 2024 (CN) 202411763828.2

(51) Int. Cl. G01C 13/00; G01S 7/481; G01S 17/89

(52) U.S. Cl. CPC G01C 13/008; G01S 7/4813; G01S 17/89

(57) ABSTRACT

An oval-scanning airborne light detection and ranging (LiDAR) bathymetry system with a controllable scanning direction includes a position and orientation system, an airborne bathymetric LiDAR unit and a rotatable mounting frame. The rotatable mounting frame includes a connection mechanism, a hollow load-bearing rotary platform and a bolt assembly. Through setting a rotation angle of a stepping motor of the hollow load-bearing rotary platform, the airborne bathymetric LiDAR unit is driven to rotate, so that long and short axes of a scanning trajectory can be flexibly adjusted according to actual needs. A positioning method based on the oval-scanning airborne LiDAR bathymetry system is also provided to calculate a spatial position of a target laser point.

### CROSS-REFERENCE TO RELATED APPLICATIONS

This application claims the benefit of priority from Chinese Patent Application No. 202411763828.2, filed on Dec. 3, 2024. The content of the aforementioned application, including any intervening amendments thereto, is incorporated herein by reference in its entirety.

### TECHNICAL FIELD

This application relates to airborne light detection and ranging (LiDAR) bathymetry (ALB) technologies, in particular to an oval-scanning airborne LiDAR bathymetry system with a controllable scanning direction and a positioning method using the same.

### BACKGROUND

Airborne light detection and ranging (LiDAR) bathymetry (ALB) system can actively emitting a blue-green laser pulse with a wavelength of 532 nm to conduct the underwater topographical survey, and can also simultaneously receive echo signals from both water and land areas to realize the land-water integrated surveying and mapping. The ALB technique features high surveying efficiency and dense measurement points, without being restricted by terrain. It can be applied to water areas where traditional shipborne sonar bathymetry systems struggle to operate, such as inland rivers, mangroves and coastal zones. In addition to the basic bathymetric function, ALB can also be applied to shoreline detection, and the acquired surveying and mapping data provides critical reference for construction and operation of water-related projects such as water conservancy and transportation, and serves as technological support for flood control and disaster mitigation, water resource management, and conservation and development of coastal resources.

However, conventional oval-scanning airborne LiDAR bathymetry (ALB) systems typically employ a fixed major axis orientation perpendicular to the flight direction. While this configuration enhances lateral overlap, it lacks the capability to dynamically optimize the scanning trajectory according to specific survey scenarios. Such limitation results in data redundancy or insufficient coverage when surveying narrow waterways or shorelines. In regions demanding high-precision measurements such as critical segments of navigational channels-a fixed scanning mode often reduces along-track point cloud density due to excessive scanning bandwidth, or impairs operational efficiency due to excessive overlap. Furthermore, in complex aquatic environments, including island reefs and meandering coastlines, where multi-directional scanning coverage is required, the absence of a mechanism for rapid adjustment of scanning orientation substantially restricts the measurement flexibility of existing systems.

To address the aforementioned issues, this application proposes a directional control device configured to dynamically adjust the orientation of the major and minor axes of the oval scanning trajectory via a stepper motor. During single-flight-line surveys, the major axis is rotated to align with the direction of the river channel or shoreline, thereby narrowing the measurement swath and increasing along-track point cloud density. For large-area mapping tasks, the system reverts to the conventional scanning mode to optimize lateral coverage. This technology addresses the limitations imposed by fixed scanning trajectories and substantially improves the operational efficiency and adaptability of ALB systems to diverse survey scenarios in complex aquatic environments.

Among the currently disclosed laser bathymetry solutions, various systems have adopted different technical approaches and deployment platforms.

Chinese patent publication No. 112526482A, entitled “A spaceborne laser LiDAR and detection method for nearshore topographic survey”, realizes laser bathymetry from a satellite platform; however, its spatial resolution is relatively low and observational flexibility is limited due to orbital altitude constraints, making it difficult to meet the high-resolution survey requirements of nearshore areas.

Chinese patent publication No. 114167436A, titled “Single-frequency bathymetric LiDAR”, achieves UAV-based bathymetric capability through optimized laser emission control and lightweight design. However, its scanning system still operates in a fixed mode and lacks the ability to dynamically adjust the orientation of the major and minor axes of the scanning trajectory based on actual survey requirements. As a result, it struggles to balance measurement efficiency and point cloud density in specialized scenarios such as narrow waterways or complex shorelines.

Chinese patent publication No. 106871990A, titled “A Method for Measuring Water Depth and LiDAR System”, innovatively employs linear polarization modulation and dual Gm-APD single-photon detection technologies, significantly improving measurement sensitivity. However, this system still adopts a fixed vertical incidence approach, lacking flexible control capability for scanning trajectories, making it difficult to adapt to precision measurement requirements in complex water environments.

Chinese patent publication No. 114236556A, titled “Seamlessly integrated LiDAR and bathymetry system of unmanned ship”, achieves autonomous navigation and measurement by integrating a LiDAR system with an unmanned surface vessel. However, its scanning mode still relies on fixed parameter settings and lacks the ability to dynamically adjust the scanning trajectory based on waterbody characteristics. As a result, it faces challenges such as insufficient or redundant data coverage when surveying areas with complex terrain.

In summary, the present disclosure provides a flexible and efficient airborne laser bathymetry solution that effectively overcomes technical bottlenecks associated with fixed scanning modes and limited scenario adaptability found in existing technologies. By employing a stepper motor to dynamically adjust the orientation of the major and minor axes of the scanning trajectory, this technology substantially improves point cloud density and coverage completeness in complex aquatic environments, while balancing measurement efficiency requirements across diverse application scenarios. This breakthrough design greatly expands the application potential of airborne bathymetric LiDAR systems, providing more reliable technical support for fields such as water conservancy engineering, navigational channel management, and coastal zone monitoring. It is expected to drive the advancement of underwater topographic surveying technologies toward intelligent and adaptive methodologies.

### SUMMARY

An object of this application is to provide an oval-scanning airborne light detection and ranging (LiDAR) bathymetry system with a controllable scanning direction and a positioning method using the same to solve problems that directions of major and minor axes in the scanning trajectory of the existing airborne LiDAR bathymetry system are unchangeable, so as to diversify the application scenario of the airborne LiDAR bathymetry systems while ensuring the surveying quality and efficiency.

In a first aspect, this application provides an oval-scanning airborne LiDAR bathymetry system with a controllable scanning direction, comprising:
an airborne bathymetric LiDAR unit;
a rotatable mounting frame; and
a position and orientation system;
wherein the airborne bathymetric LiDAR unit has an oval-scanning pattern, and is configured to emit a laser pulse and receive echo information to obtain a slant range of a target point;
the rotatable mounting frame is configured to fix the airborne bathymetric LiDAR unit on a flight carrier; and
the position and orientation system is configured to obtain spatial position and attitude information of the flight carrier.

In an embodiment, the rotatable mounting frame comprises a connection mechanism, a hollow load-bearing rotary platform and a bolt assembly.

In an embodiment, in the rotatable mounting frame, the connection mechanism comprises a cantilever snap-fit assembly and a connection plate; the cantilever snap-fit assembly comprises a plurality of cantilever snap-fit parts; the connection plate is fixed on a top of the hollow load-bearing rotary platform; and a bottom of the flight carrier is provided with a protrusion fitting the plurality of cantilever snap-fit parts, and each of the plurality of cantilever snap-fit parts is connected with the protrusion;
in the rotatable mounting frame, a bottom of the hollow load-bearing rotary platform is connected with a top of the airborne bathymetric LiDAR unit through the bolt assembly; the hollow load-bearing rotary platform is configured to be driven by a stepping motor; and the stepping motor is configured to be controlled to rotate to drive the airborne bathymetric LiDAR unit to rotate;
in the rotatable mounting frame, the bolt assembly comprises a plurality of bolts, and the plurality of bolts are circularly arranged along a periphery of the hollow load-bearing rotary platform; and each of the plurality of bolts is connected with the hollow load-bearing rotary platform and a top of the airborne bathymetric LiDAR unit.

This application also provides a positioning method based on the oval-scanning airborne LiDAR bathymetry system, comprising:
(S1) setting a rotation angle of a stepping motor of a hollow load-bearing rotary platform;
(S2) obtaining a first slant range of a laser beam from an emission point to a target point, a second slant range of the laser beam from the emission point to the target point, a rotation angle of a drive motor of a mirror of the airborne bathymetric LiDAR unit, a three-dimensional coordinate of a center of the position and orientation system in a world geodetic system-1984 (WGS-84) coordinate system and an attitude angle of a flight carrier, wherein the first slant range corresponds to transmission of the laser beam in air, and the second slant range corresponds to underwater transmission of the laser beam;
(S3) according to the rotation angle of the stepping motor, the first slant range, the second slant range and the rotation angle of the drive motor, calculating a three-dimensional coordinate of the target point in a laser-scanning reference coordinate system;
(S4) measuring, by a total station, an eccentric correction from a center of the mirror of the airborne bathymetric LiDAR unit to the center of the position and orientation system; and according to the eccentric correction, converting the three-dimensional coordinate of the target point in the laser-scanning reference coordinate system to a carrier coordinate system;
(S5) according to the attitude angle of the flight carrier, converting a three-dimensional coordinate of the target point in the carrier coordinate system to a navigation coordinate system;
(S6) converting the three-dimensional coordinate of the center of the position and orientation system in the WGS-84 coordinate system to an earth-centered, earth-fixed (ECEF) coordinate system; and in combination with a three-dimensional coordinate of the target point in the navigation coordinate system, calculating a three-dimensional coordinate of the target point in the ECEF coordinate system; and
(S7) converting the three-dimensional coordinate of the target point in the ECEF coordinate system to the WGS-84 coordinate system to obtain a three-dimensional coordinate of the target point in the WGS-84 coordinate system; and locating the target point based on the three-dimensional coordinate of the target point in the WGS-84 coordinate system.

In an embodiment, step (S3) comprises:
establishing a laser-scanning coordinate system O-XYZ with the center of the mirror as an origin O, wherein a Z-axis of the laser-scanning coordinate system O-XYZ is perpendicular to the flight carrier; an X-axis of the laser-scanning coordinate system O-XYZ points to a direction opposite to a direction of the laser beam; a Y-axis of the laser-scanning coordinate system O-XYZ and the X-axis of the laser-scanning coordinate system O-XYZ together form a right-handed spatial rectangular coordinate system; and the laser beam and a rotation shaft of the drive motor are located in an XZ plane;
establishing a laser-scanning auxiliary coordinate system O-X′Y′Z′, wherein the laser-scanning auxiliary coordinate system O-X′Y′Z′ is established by rotating the laser-scanning coordinate system O-XYZ counterclockwise by 45° around the Y-axis of the laser-scanning coordinate system O-XYZ with the origin O as a center;
a direction vector \vec{F}′ of a normal of the mirror in the laser-scanning auxiliary coordinate system O-X′Y′Z′ is shown as:

$${\vec{F}}^{′} = [ \begin{matrix}{F}_{x ′} \\ {F}_{y ′} \\ {F}_{z ′}\end{matrix} ] = [ \begin{matrix}sin ( 5 ° ) cos ( θ ) \\ sin ( 5 ° ) sin ( θ ) \\ - cos ( 5 ° )\end{matrix} ] ,$$

wherein θ represents the rotation angle of the drive motor;
according to a converting relationship between the laser-scanning coordinate system O-XYZ and the laser-scanning auxiliary coordinate system O-X′Y′Z′, obtaining the direction vector \vec{F}′ of the normal of the mirror in the laser-scanning coordinate system O-XYZ through the following formula:

$$\vec{F} = [ \begin{matrix}{F}_{x} \\ {F}_{y} \\ {F}_{z}\end{matrix} ] = {R}_{y ′} ( 45 ° ) \cdot {\vec{F}}^{′} = [ \begin{matrix}sin ( 5 ° ) cos ( θ ) cos ( 45 ° ) + cos ( 5 ° ) cos ( 45 ° ) \\ sin ( 5 ° ) sin ( θ ) \\ sin ( 5 ° ) cos ( θ ) cos ( 45 ° ) - cos ( 5 ° ) cos ( 45 ° )\end{matrix} ] ;$$

wherein an angle φ_{Fx} between a projection of the normal of the mirror on the XZ plane and the Z-axis of the laser-scanning coordinate system O-XYZ is shown as follows:

$${φ}_{Fx} = {tan}^{- 1} ( {F}_{x} / \vert {F}_{z} \vert ) ;$$

according to a geometric relationship, an angle φₓ between a projection of a reflected light beam from the target point on the XZ plane and the Z-axis of the laser-scanning coordinate system O-XYZ is shown as follows:

$${φ}_{x} = 2 {φ}_{Fx} - 90 ° = 2 {tan}^{- 1} ( {F}_{x} / \vert {F}_{z} \vert ) - 90 ° ;$$

and
an angle φ_{Fy} between a projection of the normal of the mirror on a YZ plane and the Z-axis of the laser-scanning coordinate system O-XYZ is shown as follows:

$${φ}_{Fy} = {tan}^{- 1} ( {F}_{y} / \vert {F}_{z} \vert ) ;$$

and
according to the geometric relationship, an angle φ_{y} between a projection of the reflected light on a XY plane and the Z-axis of the laser-scanning coordinate system O-XYZ is shown as follows:

$${φ}_{y} = {φ}_{Fy} = {tan}^{- 1} ( {F}_{y} / \vert {F}_{z} \vert ) ;$$

according to the angle φₓ and the angle φ_{y}, obtaining a scanning angle φ shown as follows:

$$φ = {tan}^{- 1} ( \sqrt{{( tan {φ}_{x} )}^{2} + {( tan {φ}_{y} )}^{2}} ) ;$$

according to the scanning angle φ, calculating a perpendicular distance h₁ from the center of the mirror to an incidence point of the laser beam on a water surface through a formula as follows:

$${h}_{1} = {d}_{1} cos φ ;$$

wherein d₁ represents the first slant range;
according to the geometric relationship, calculating a three-dimensional coordinate of the incidence point of the laser beam in the laser-scanning coordinate system O-XYZ through the following formula:

$$[ \begin{matrix}{x}_{S} \\ {y}_{S} \\ {z}_{S}\end{matrix} ] = [ \begin{matrix}H tan {φ}_{x} \\ H tan {φ}_{y} \\ - {h}_{1}\end{matrix} ] ;$$

calculating an azimuth angle Ψ through the following formula:

$$Ψ = {tan}^{- 1} ( {y}_{S} / {x}_{S} ) ;$$

according to a Snell's law, calculating a refraction angle φ′ of the laser beam through the following formula:

$${φ}^{′} = {sin}^{- 1} ( sin φ / 1.33333 ) ;$$

and
calculating a water depth h₂ through a formula as follows:

$${h}_{2} = {d}_{2} cos {φ}^{′} ;$$

wherein d₂ represents the second slant range of the laser beam;
according to the geometric relationship, calculating a three-dimensional coordinate of an incidence point F of the laser beam at a water bottom in the laser-scanning coordinate system through a formula as follows:

$$[ \begin{matrix}{x}_{F} \\ {y}_{F} \\ {z}_{F}\end{matrix} ] = [ \begin{matrix}( {d}_{1} sin φ + {d}_{2} sin {φ}^{′} ) cos Ψ \\ ( {d}_{1} sin φ + {d}_{2} sin {φ}^{′} ) sin Ψ \\ - {h}_{1} - {h}_{2}\end{matrix} ] ;$$

establishing the laser-scanning reference coordinate system O-X″Y″Z″ with the center of the mirror as origin O, wherein a Y″-axis of the laser-scanning reference coordinate system O-X″Y″Z″ is a flight direction; a Z″-axis of the laser-scanning reference coordinate system O-X″Y″Z″ is perpendicular to the flight carrier, and points upward; and an X″-axis of the laser-scanning reference coordinate system O-X″Y″Z″, the Y″-axis and the Z″-axis form a right-handed spatial rectangular coordinate system;
when the rotation angle of the stepping motor of the hollow load-bearing rotary platform is 0°, the Y-axis of the laser-scanning coordinate system O-XYZ points to the flight direction, that is, the laser-scanning coordinate system O-XYZ and the laser-scanning reference coordinate system O-X″Y″Z″ are co-directional; when the stepping motor of the hollow load-bearing rotary platform rotates clockwise, the stepping motor drives the airborne bathymetric LiDAR unit to rotate clockwise with the center of the mirror as an origin, that is, the laser-scanning coordinate system O-XYZ rotates clockwise with the origin O around the Y-axis;
wherein the laser-scanning reference coordinate system and the laser-scanning coordinate system has a relationship as follows:

$$[ \begin{matrix}{x}^{″} \\ {y}^{″} \\ {z}^{″}\end{matrix} ] = {R}_{y} ( τ ) \cdot [ \begin{matrix}x \\ y \\ z\end{matrix} ] = [ \begin{matrix}cos τ & 0 & sin τ \\ 0 & 1 & 0 \\ - sin τ & 0 & cos τ\end{matrix} ] \cdot [ \begin{matrix}x \\ y \\ z\end{matrix} ] ;$$

wherein τ represents the rotation angle of the stepping motor of the hollow load-bearing rotary platform;
according to the converting relationship, when the rotation angle of the stepping motor of the hollow load-bearing rotary platform is τ, calculating a three-dimensional coordinate of an incidence point S on the water surface of the laser beam in the laser-scanning coordinate system through a formula as follows:

$$[ \begin{matrix}{{x}^{″}}_{S} \\ {{y}^{″}}_{S} \\ {{z}^{″}}_{S}\end{matrix} ] = {R}_{y} ( τ ) \cdot [ \begin{matrix}H tan {φ}_{x} \\ H tan {φ}_{y} \\ - {h}_{1}\end{matrix} ] ;$$

and
calculating the incidence point F of the laser beam at the water bottom in the laser-scanning coordinate system through a formula as follows:

$$[ \begin{matrix}{{x}^{″}}_{F} \\ {{y}^{″}}_{F} \\ {{z}^{″}}_{F}\end{matrix} ] = {R}_{y} ( τ ) \cdot [ \begin{matrix}( {d}_{1} sin φ + {d}_{2} sin {φ}^{′} ) cos Ψ \\ ( {d}_{1} sin φ + {d}_{2} sin {φ}^{′} ) sin Ψ \\ - {h}_{1} - {h}_{2}\end{matrix} ] .$$

Compared to the prior art, this application has the following beneficial effects.

This application provides the rotatable mounting frame, through setting the rotation angle of the stepping motor of the hollow load-bearing rotary platform, the airborne bathymetric LiDAR unit is driven to rotate, so that the directions of the directions of long and short axes of scanning trajectory can be flexibly adjusted according to actual needs. This application provides the positioning method based on the oval-scanning airborne light detection and ranging (LiDAR) bathymetry system, according to the rotation angle of the stepping motor of the hollow load-bearing rotary platform, a space position of a target laser point is calculated. By realizing variable directions of long and short axes of the scanning trajectory by the oval-scanning airborne LiDAR bathymetry system, the measurement flexibility is greatly improved, which makes the system be applied to various application scenarios to effectively ensure measurement quality and efficiency.

### BRIEF DESCRIPTION OF THE DRAWINGS

FIG. 1 is a schematic diagram of an oval-scanning airborne light detection and ranging (LiDAR) bathymetry system with a controllable scanning direction according to an embodiment of the present disclosure.

FIG. 2 is a schematic diagram of the system from another perspective according to an embodiment of the present disclosure.

FIG. 3 is a flow chart of a positioning method based on the system according to an embodiment of the present disclosure.

FIG. 4 shows a laser-scanning reference coordinate system of the system according to an embodiment of the present disclosure.

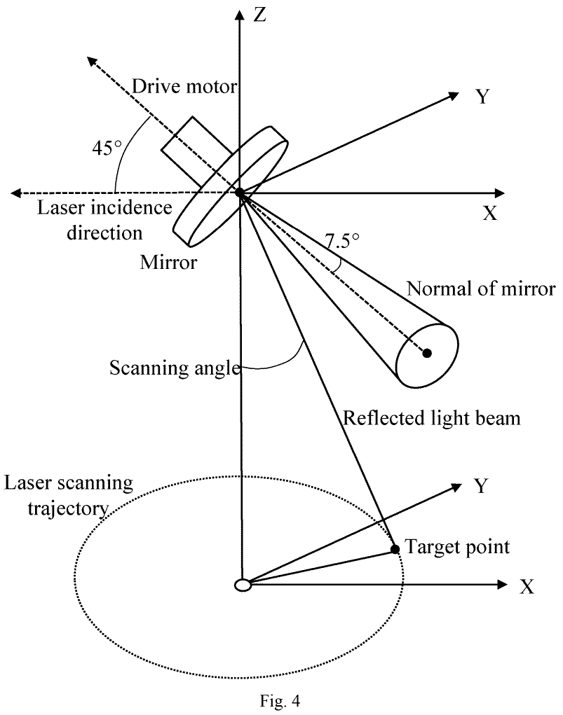

FIG. 5 is a schematic diagram of a measurement in a coastal zone according to an embodiment of the present disclosure.

FIG. 6 is a schematic diagram of a measurement in a waterline according to an embodiment of the present disclosure.

FIG. 7 is a schematic diagram of a measurement in an inland river channel according to an embodiment of the present disclosure.

### DETAILED DESCRIPTION OF EMBODIMENTS

To make the above object, features and advantages of the present disclosure more clearly, the present disclosure will be further described below with reference to the accompanying drawings and the specific embodiments. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

### Embodiment 1

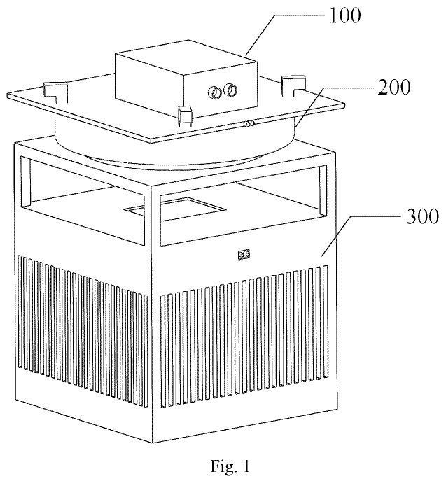

Referring to FIG. 1, an oval-scanning airborne light detection and ranging (LiDAR) bathymetry system with a controllable scanning direction includes a position and orientation system 100, a rotatable mounting frame 200 and an airborne bathymetric LiDAR unit 300. The position and orientation system 100 is configured to obtain spatial position and attitude information of the flight carrier. The rotatable mounting frame 200 is configured to fix the airborne bathymetric LiDAR unit 300 on a flight carrier. The airborne bathymetric LiDAR unit 300 has an oval-scanning pattern, and is configured to emit a laser pulse and receive echo information to obtain a slant range of a target point.

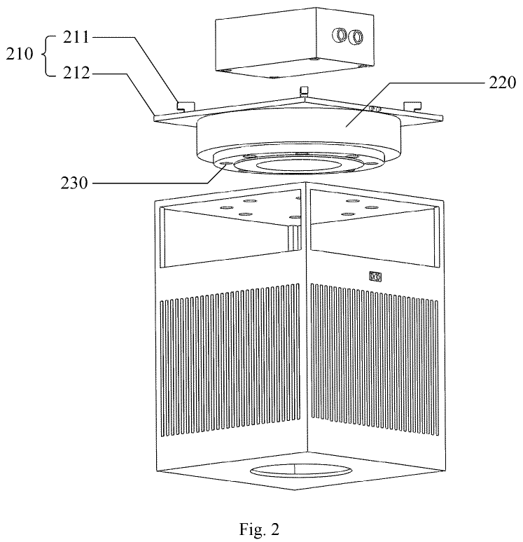

Referring to FIG. 2, the rotatable mounting frame 200 includes a connection mechanism 210, a hollow load-bearing rotary platform 220 and a bolt assembly 230.

The connection mechanism 210 includes a cantilever snap-fit assembly 211 and a connection plate 212. The cantilever snap-fit assembly 211 includes a plurality of cantilever snap-fit parts. The connection plate 212 is fixed on a top of the hollow load-bearing rotary platform 220. A bottom of the flight carrier is provided with a protrusion fitting the plurality of cantilever snap-fit parts, and each of the plurality of cantilever snap-fit parts is connected with the protrusion.

A bottom of the hollow load-bearing rotary platform 220 is connected with a top of the airborne bathymetric LiDAR unit 300 through the bolt assembly 230. The hollow load-bearing rotary platform 220 is configured to be driven by a stepping motor. The stepping motor is configured to be controlled to rotate to drive the airborne bathymetric LiDAR unit 300 to rotate. The bolt assembly 230 includes a plurality of bolts, and the plurality of bolts are circularly arranged along a periphery of the hollow load-bearing rotary platform 220. Each of the plurality of bolts is connected with the hollow load-bearing rotary platform 220 and a top of the airborne bathymetric LiDAR unit.

### Embodiment 2

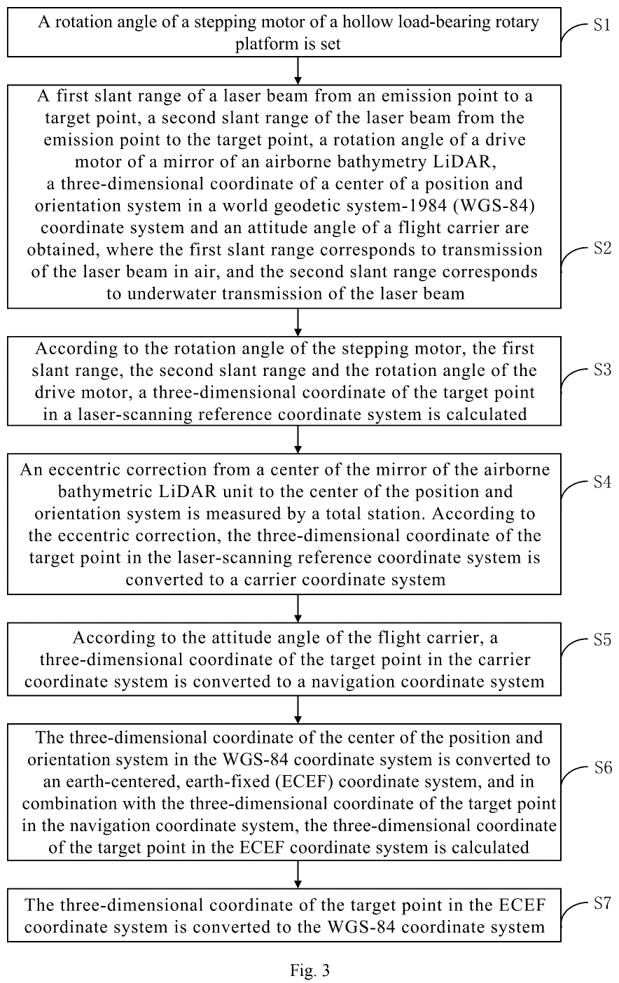

Referring to FIG. 3, a positioning method based on the oval-scanning airborne LiDAR bathymetry system includes the following steps.
(S1) A rotation angle of a stepping motor of a hollow load-bearing rotary platform is set.
(S2) A first slant range of a laser beam from an emission point to a target point, a second slant range of the laser beam from the emission point to the target point, a rotation angle of a drive motor of a mirror of the airborne bathymetric LiDAR unit, a three-dimensional coordinate of a center of the position and orientation system in a world geodetic system-1984 (WGS-84) coordinate system and an attitude angle of a flight carrier are obtained, where the first slant range corresponds to transmission of the laser beam in air, and the second slant range corresponds to underwater transmission of the laser beam.
(S3) According to the rotation angle of the stepping motor of the hollow load-bearing rotary platform, the first slant range, the second slant range and the rotation angle of the drive motor, a three-dimensional coordinate of the target point in a laser-scanning reference coordinate system is calculated.
(S4) An eccentric correction from a center of the mirror of the airborne bathymetric LiDAR unit to the center of the position and orientation system is measured by a total station. The three-dimensional coordinate of the target point in the laser-scanning reference coordinate system is converted to a carrier coordinate system.
(S5) According to the attitude angle of the flight carrier, a three-dimensional coordinate of the target point in the carrier coordinate system is converted to a navigation coordinate system.
(S6) The three-dimensional coordinate of the center of the position and orientation system in the WGS-84 coordinate system is converted to an earth-centered, earth-fixed (ECEF) coordinate system, and in combination with the three-dimensional coordinate of the target point in the navigation coordinate system, a three-dimensional coordinate of the target point in the ECEF coordinate system is calculated.
(S7) The three-dimensional coordinate of the target point in the ECEF coordinate system is converted to the WGS-84 coordinate system to obtain a three-dimensional coordinate of the target point in the WGS-84 coordinate system, and the target point is located based on the three-dimensional coordinate in the WGS-84 coordinate system.

In an embodiment, step (S1) includes the following steps.

Referring to FIG. 3, an incidence ray of the airborne bathymetric LiDAR unit and a rotation shaft of the drive motor are in the same plane and form an angle of 45°. A normal of the mirror is not in the same direction as the rotation shaft of the drive motor, and there is an angle of 7.5° between therebetween. When the mirror is driven by the driven motor to rotate at high speed, the normal of the mirror forms a cone in space. The laser beam which is horizontally incident is reflected by the mirror and directed in different directions, forming oval-shaped laser foot points on a target plane.

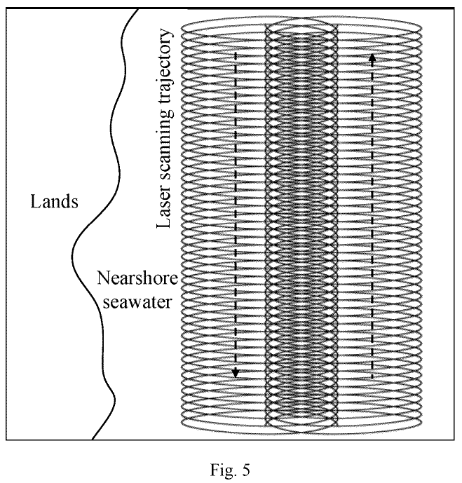

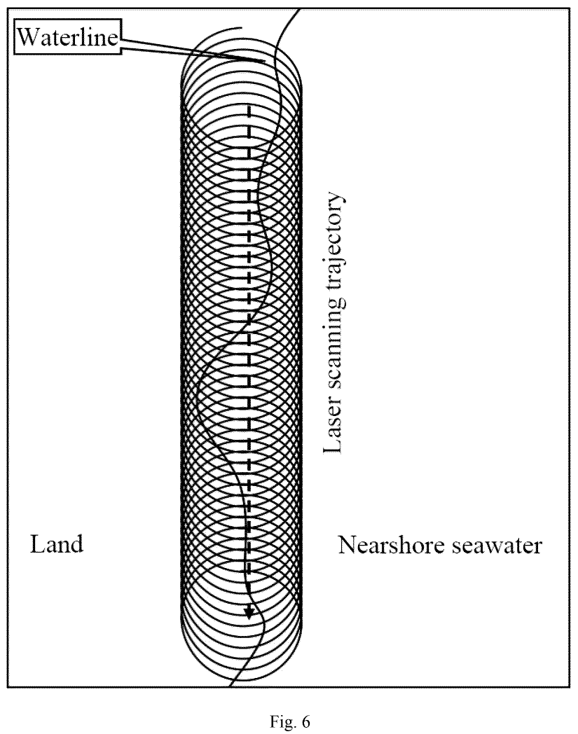

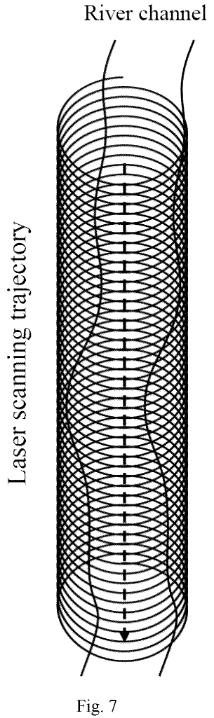

The incidence ray of the airborne bathymetric LiDAR unit is generally perpendicular to a flight direction of the flight carrier, that is, a long axis of the scanning trajectory is set to be perpendicular to the flight direction of the flight carrier, so as to maximize a lateral scanning angle and improve a lateral overlap degree. Referring to FIG. 5, a dotted line is the flight direction of the flight carrier, when an operation scene is a large-scale measurement, such as water bottom topography mapping in the coastal zone, the rotation angle of the stepping motor of the hollow load-bearing rotary platform is set to 0°, so that the long axis of the scanning trajectory is perpendicular to the flight direction of the flight carrier. Referring to FIGS. 6-7, when an operation scene is a small-scale measurement, such as waterline measurement and topographic mapping of inland river channel, at this time, only one measurement band is needed to cover a target area. Through setting the rotation angle of the stepping motor of the hollow load-bearing rotary platform, the airborne bathymetric LiDAR unit is driven to rotate, so that the long axis of the scanning trajectory is perpendicular to a waterline or a direction of a river channel, which reduces measuring bandwidth, improves azimuth overlap degree and improve measurement efficiency while maintaining area measurement density.

In an embodiment, step (S3) includes the following steps.

A laser-scanning coordinate system O-XYZ with the center of the mirror as an origin O is established, where a Z-axis of the laser-scanning coordinate system O-XYZ is perpendicular to the flight carrier, an X-axis of the laser-scanning coordinate system O-XYZ points to a direction opposite to a direction of the laser beam. A Y-axis of the laser-scanning coordinate system O-XYZ and the X-axis of the laser-scanning coordinate system O-XYZ together form a right-handed spatial rectangular coordinate system. The laser beam and the rotation shaft of the drive motor are located in an XZ plane.

A laser-scanning auxiliary coordinate system O-X′Y′Z′ is established, where the laser-scanning auxiliary coordinate system O-X′Y′Z′ is established by rotating the laser-scanning coordinate system O-XYZ counterclockwise by 45° around the Y-axis of the laser-scanning coordinate system O-XYZ with the origin O as a center.

A direction vector \vec{F}′ of the normal of the mirror in the laser-scanning auxiliary coordinate system O-X′Y′Z′ is shown as follows:

$${\vec{F}}^{′} = [ \begin{matrix}{F}_{x ′} \\ {F}_{y ′} \\ {F}_{z ′}\end{matrix} ] = [ \begin{matrix}sin ( 5 ° ) cos ( θ ) \\ sin ( 5 ° ) sin ( θ ) \\ - cos ( 5 ° )\end{matrix} ] ,$$

where θ represents the rotation angle of the drive motor.

According to a converting relationship between the laser-scanning coordinate system O-XYZ and the laser-scanning auxiliary coordinate system O-X′Y′Z′, the direction vector \vec{F}′ of the normal of the mirror in the laser-scanning coordinate system O-XYZ is obtained through a formula as follows:

$$\vec{F} = [ \begin{matrix}{F}_{x} \\ {F}_{y} \\ {F}_{z}\end{matrix} ] = {R}_{y ′} ( 45 ° ) \cdot {\vec{F}}^{′} = [ \begin{matrix}sin ( 5 ° ) cos ( θ ) cos ( 45 ° ) + cos ( 5 ° ) cos ( 45 ° ) \\ sin ( 5 ° ) sin ( θ ) \\ sin ( 5 ° ) cos ( θ ) cos ( 45 ° ) - cos ( 5 ° ) cos ( 45 ° )\end{matrix} ] .$$

An angle φ_{Fx} between a projection of the normal of the mirror on the XZ plane and the Z-axis of the laser-scanning coordinate system O-XYZ is shown as follows:

$${φ}_{Fx} = {tan}^{- 1} ( {F}_{x} / \vert {F}_{z} \vert ) .$$

According to a geometric relationship, an angle φₓ between a projection of a reflected light on the XZ plane and the Z-axis of the laser-scanning coordinate system O-XYZ is shown as follows:

$${φ}_{x} = 2 {φ}_{Fx} - 90 ° = 2 {tan}^{- 1} ( {F}_{x} / \vert {F}_{z} \vert ) - 90 ° .$$

An angle φ_{Fy} between a projection of the reflected light on a YZ plane and the Z-axis of the laser-scanning coordinate system O-XYZ is shown as follows:

$${φ}_{Fy} = {tan}^{- 1} ( {F}_{y} / \vert {F}_{z} \vert ) .$$

According to a geometric relationship, an angle φ_{y} between a projection of the reflected light beam from the target point on a XY plane and the Z-axis of the laser-scanning coordinate system O-XYZ is shown as follows:

$${φ}_{y} = {φ}_{Fy} = {tan}^{- 1} ( {F}_{y} / \vert {F}_{z} \vert ) .$$

According to the angle φₓ and the angle φ_{y}, a scanning angle φ is obtained through a formula as follows:

$$φ = {tan}^{- 1} ( \sqrt{{( tan {φ}_{x} )}^{2} + {( tan {φ}_{y} )}^{2}} ) .$$

According to the scanning angle φ, a perpendicular distance h₁ from the center of the mirror to an incidence point of the laser beam is calculated through a formula as follows:

$${h}_{1} = {d}_{1} cos φ ,$$

where d₁ represents the first slant range.

According to the geometric relationship, a three-dimensional coordinate of the incidence point of the laser beam in the laser-scanning coordinate system is calculated through a formula as follows:

$$[ \begin{matrix}{x}_{S} \\ {y}_{S} \\ {z}_{S}\end{matrix} ] = [ \begin{matrix}H tan {φ}_{x} \\ H tan {φ}_{y} \\ - {h}_{1}\end{matrix} ] .$$

An azimuth angle Ψ is calculated through the following formula:

$$Ψ = {tan}^{- 1} ( {y}_{S} / {x}_{S} ) .$$

According to a Snell's law, a refraction angle φ′ of the laser beam is calculated through the following formula:

$${φ}^{′} = {sin}^{- 1} ( sin φ / 1.33333 ) .$$

A water depth h₂ is calculated through a formula as follows:

$${h}_{2} = {d}_{2} cos {φ}^{′} ,$$

where d₂ represents the second slant ranges.

According to the geometric relationship, a three-dimensional coordinate of an incidence point F of the laser beam at a water bottom in the laser-scanning coordinate system is calculated through a formula as follows:

$$[ \begin{matrix}{x}_{F} \\ {y}_{F} \\ {z}_{F}\end{matrix} ] = [ \begin{matrix}( {d}_{1} sin φ + {d}_{2} sin {φ}^{′} ) cos Ψ \\ ( {d}_{1} sin φ + {d}_{2} sin {φ}^{′} ) sin Ψ \\ - {h}_{1} - {h}_{2}\end{matrix} ] .$$

The laser-scanning reference coordinate system O-X″Y″Z″ with the center of the mirror as the origin O is established, where a Y″-axis of the laser-scanning reference coordinate system O-X″Y″Z″ is the flight direction, a Z″-axis of the laser-scanning reference coordinate system O-X″Y″Z″ is perpendicular to the flight carrier and points upward, and an X″-axis of the laser-scanning reference coordinate system O-X″Y″Z″, the Y″-axis and the Z″-axis form a right-handed spatial rectangular coordinate system. When the rotation angle of the stepping motor of the hollow load-bearing rotary platform is 0°, the Y-axis of the laser-scanning coordinate system O-XYZ points to the flight direction, that is, the laser-scanning coordinate system O-XYZ and the laser-scanning reference coordinate system O-X″Y″Z″ are co-directional. When the stepping motor of the hollow load-bearing rotary platform rotates clockwise, the stepping motor drives the airborne bathymetric LiDAR unit to rotate clockwise with the center of the mirror as an origin, that is, the laser-scanning coordinate system O-XYZ rotates clockwise with the origin O around the Y-axis.

The laser-scanning reference coordinate system and the laser-scanning coordinate system has a relationship as follows:

$$[ \begin{matrix}{x}^{″} \\ {y}^{″} \\ {z}^{″}\end{matrix} ] = {R}_{y} ( τ ) \cdot [ \begin{matrix}x \\ y \\ z\end{matrix} ] = [ \begin{matrix}cos τ & 0 & sin τ \\ 0 & 1 & 0 \\ - sin τ & 0 & cos τ\end{matrix} ] \cdot [ \begin{matrix}x \\ y \\ z\end{matrix} ] ,$$

where τ represents the rotation angle of the stepping motor of the hollow load-bearing rotary platform.

According to the converting relationship, when the rotation angle of the stepping motor of the hollow load-bearing rotary platform is τ, a three-dimensional coordinate of an incidence point S on the water surface of the laser beam in the laser-scanning coordinate system is calculated through a formula as follows:

$$[ \begin{matrix}{{x}^{″}}_{S} \\ {{y}^{″}}_{S} \\ {{z}^{″}}_{S}\end{matrix} ] = {R}_{y} ( τ ) \cdot [ \begin{matrix}H tan {φ}_{x} \\ H tan {φ}_{y} \\ - {h}_{1}\end{matrix} ] .$$

The incidence point F of the laser beam at the water bottom in the laser-scanning coordinate system is calculated through a formula as follows:

$$[ \begin{matrix}{{x}^{″}}_{F} \\ {{y}^{″}}_{F} \\ {{z}^{″}}_{F}\end{matrix} ] = {R}_{y} ( τ ) \cdot [ \begin{matrix}( {d}_{1} sin φ + {d}_{2} sin {φ}^{′} ) cos Ψ \\ ( {d}_{1} sin φ + {d}_{2} sin {φ}^{′} ) sin Ψ \\ - {h}_{1} - {h}_{2}\end{matrix} ] .$$

Specific embodiments described above further describe the objects, technical solutions and beneficial effects in detail. It should be noted that described above are only specific embodiments which are not intended to limit this application. Any modifications, equivalent replacements and improvements can be easily thought by those skilled in the art, shall fall within the scope of this application defined by the appended claims.

What is claimed is:

1. An oval-scanning airborne light detection and ranging (LiDAR) bathymetry system with a controllable scanning direction, comprising:
an airborne bathymetric LiDAR unit;
a rotatable mounting frame; and
a position and orientation system;
wherein the airborne bathymetric LiDAR unit has an oval-scanning pattern, and is configured to emit a laser pulse and receive echo information to obtain a slant range of a target point;
the rotatable mounting frame is configured to fix the airborne bathymetric LiDAR unit on a flight carrier; and
the position and orientation system is configured to obtain spatial position and attitude information of the flight carrier.

2. The oval-scanning LiDAR bathymetry system of claim 1, wherein the rotatable mounting frame comprises a connection mechanism, a hollow load-bearing rotary platform and a bolt assembly.

3. The oval-scanning LiDAR bathymetry system of claim 2, wherein the connection mechanism comprises a cantilever snap-fit assembly and a connection plate; the cantilever snap-fit assembly comprises a plurality of cantilever snap-fit parts; the connection plate is fixed on a top of the hollow load-bearing rotary platform; and a bottom of the flight carrier is provided with a protrusion fitting the plurality of cantilever snap-fit parts, and each of the plurality of cantilever snap-fit parts is connected with the protrusion.

4. The oval-scanning LiDAR bathymetry system of claim 2, further comprising:
a stepping motor;
wherein the stepping motor is configured to drive the hollow load-bearing rotary platform to rotate, so as to drive the airborne bathymetric LiDAR unit to rotate; and a bottom of the hollow load-bearing rotary platform is connected with a top of the airborne bathymetric LiDAR unit through the bolt assembly.

5. The oval-scanning LiDAR bathymetry system of claim 2, wherein the bolt assembly comprises a plurality of bolts, and the plurality of bolts are circularly arranged along a periphery of the hollow load-bearing rotary platform; and each of the plurality of bolts is threadedly connected with the hollow load-bearing rotary platform and a top of the airborne bathymetric LiDAR unit.

6. A positioning method based on the oval-scanning airborne LiDAR bathymetry system of claim 1, comprising:
(S1) setting a rotation angle of a stepping motor of the hollow load-bearing rotary platform;
(S2) obtaining a first slant range of a laser beam from an emission point to the target point, a second slant range of the laser beam from the emission point to the target point, a rotation angle of a drive motor of a mirror of the airborne bathymetric LiDAR unit, a three-dimensional coordinate of a center of the position and orientation system in a world geodetic system-1984 (WGS-84) coordinate system and an attitude angle of the flight carrier, wherein the first slant range corresponds to transmission of the laser beam in air, and the second slant range corresponds to underwater transmission of the laser beam;
(S3) according to the rotation angle of the stepping motor, the first slant range, the second slant range and the rotation angle of the drive motor, calculating a three-dimensional coordinate of the target point in a laser-scanning reference coordinate system;
(S4) measuring, by a total station, an eccentric correction from a center of the mirror of the airborne bathymetric LiDAR unit to the center of the position and orientation system; and according to the eccentric correction, converting the three-dimensional coordinate of the target point in the laser-scanning reference coordinate system to a carrier coordinate system;
(S5) according to the attitude angle of the flight carrier, converting a three-dimensional coordinate of the target point in the carrier coordinate system to a navigation coordinate system;
(S6) converting the three-dimensional coordinate of the center of the position and orientation system in the WGS-84 coordinate system to an earth-centered, earth-fixed (ECEF) coordinate system; and in combination with a three-dimensional coordinate of the target point in the navigation coordinate system, calculating a three-dimensional coordinate of the target point in the ECEF coordinate system; and
(S7) converting the three-dimensional coordinate of the target point in the ECEF coordinate system to the WGS-84 coordinate system to obtain a three-dimensional coordinate of the target point in the WGS-84 coordinate system; and locating the target point based on the three-dimensional coordinate of the target point in the WGS-84 coordinate system.

7. The positioning method of claim 6, wherein step (S3) comprises:
establishing a laser-scanning coordinate system O-XYZ with the center of the mirror as an origin O, wherein a Z-axis of the laser-scanning coordinate system O-XYZ is perpendicular to the flight carrier, and points upward; an X-axis of the laser-scanning coordinate system O-XYZ points to a direction opposite to a direction of the laser beam; a Y-axis of the laser-scanning coordinate system O-XYZ and the X-axis of the laser-scanning coordinate system O-XYZ together form a right-handed spatial rectangular coordinate system; and the laser beam and a rotation shaft of the drive motor are located in an XZ plane;
establishing a laser-scanning auxiliary coordinate system O-X′Y′Z′, wherein the laser-scanning auxiliary coordinate system O-X′Y′Z′ is established by rotating the laser-scanning coordinate system O-XYZ counterclockwise by 45° around the Y-axis of the laser-scanning coordinate system O-XYZ with the origin O as a center; and
a direction vector F′of a normal of the mirror in the laser-scanning auxiliary coordinate system O-X′Y′Z′ is shown as:
$${\vec{F}}^{′} = [ \begin{matrix}{F}_{{x}^{′}} \\ {F}_{{y}^{′}} \\ {F}_{{z}^{′}}\end{matrix} ] = [ \begin{matrix}sin ( 5 ° ) cos ( θ ) \\ sin ( 5 ° ) sin ( θ ) \\ - cos ( 5 ° )\end{matrix} ] ,$$
wherein 0 represents the rotation angle of the drive motor;
according to a converting relationship between the laser-scanning coordinate system O-XYZ and the laser-scanning auxiliary coordinate system O-X′Y′Z′, obtaining a direction vector F of the normal of the mirror in the laser-scanning coordinate system O-XYZ through the following formula:
$$\vec{F} = [ \begin{matrix}{F}_{x} \\ {F}_{y} \\ {F}_{z}\end{matrix} ] = {R}_{y ′} ( 45 ° ) \cdot {\vec{F}}^{′} = [ \begin{matrix}sin ( 5 ° ) cos ( θ ) cos ( 45 ° ) + cos ( 5 ° ) cos ( 45 ° ) \\ sin ( 5 ° ) sin ( θ ) \\ sin ( 5 ° ) cos ( θ ) cos ( 45 ° ) - cos ( 5 ° ) cos ( 45 ° )\end{matrix} ] ;$$
wherein an angle QFx between a projection of the normal of the mirror on the XZ plane and the Z-axis of the laser-scanning coordinate system O-XYZ is shown as follows:
$${φ}_{F x} = {tan}^{- 1} ( {F}_{x} / \vert {F}_{z} \vert ) ;$$
according to a geometric relationship, an angle Qx between a projection of a reflected light beam from the target point on the XZ plane and the Z-axis of the laser-scanning coordinate system O-XYZ is shown as follows:
$${φ}_{x} = 2 {φ}_{F x} - 90 ° = 2 {tan}^{- 1} ( {F}_{x} / \vert {F}_{z} \vert ) - 90 ° ;$$
and an angle OFy between a projection of the normal of the mirror on a YZ plane and the Z-axis of the laser-scanning coordinate system O-XYZ is shown as follows:
$${φ}_{F y} = {tan}^{- 1} ( {F}_{y} / \vert {F}_{z} \vert ) ;$$
and according to the geometric relationship, an angle dy between a projection of the reflected light beam from the target point on a XY plane and the Z-axis of the laser-scanning coordinate system O-XYZ is shown as follows:
$${φ}_{y} = {φ}_{F y} = {tan}^{- 1} ( {F}_{y} / \vert {F}_{z} \vert ) ;$$
according to the angle Qx and the angle dy, obtaining a scanning angle q through the following formula:
$$φ = {tan}^{- 1} ( \sqrt{{( tan {φ}_{x} )}^{2} + {( tan {φ}_{y} )}^{2}} ) ;$$
according to the scanning angle q, calculating a perpendicular distance h1 from the center of the mirror to an incidence point of the laser beam on a water surface through the following formula:
$${h}_{1} = {d}_{1} cos φ ;$$
wherein d1 represents the first slant range;
according to the geometric relationship, calculating a three-dimensional coordinate of the incidence point of the laser beam in the laser-scanning coordinate system O-XYZ through the following formula:
$$[ \begin{matrix}{x}_{S} \\ {y}_{S} \\ {z}_{S}\end{matrix} ] = [ \begin{matrix}H tan {φ}_{x} \\ H tan {φ}_{y} \\ - {h}_{1}\end{matrix} ] ;$$
calculating an azimuth angle Y′ through the following formula:
$$Ψ = {tan}^{- 1} ( {y}_{S} / {x}_{S} ) ;$$
according to a Snell's law, calculating a refraction angle q′ of the laser beam on the water surface through the following formula:
$${φ}^{′} = {sin}^{- 1} ( sin φ / 1.33333 ) ;$$
calculating a water depth h2 through a formula as follows:
$${h}_{2} = {d}_{2} cos {φ}^{′} ;$$
wherein d2 represents the second slant range of the laser beam;
according to the geometric relationship, calculating a three-dimensional coordinate of an incidence point F of the laser beam at a water bottom in the laser-scanning coordinate system through a formula as follows:
$$[ \begin{matrix}{x}_{F} \\ {y}_{F} \\ {z}_{F}\end{matrix} ] = [ \begin{matrix}( {d}_{1} sin φ + {d}_{2} sin {φ}^{′} ) cos Ψ \\ ( {d}_{1} sin φ + {d}_{2} sin {φ}^{′} ) sin Ψ \\ - {h}_{1} - {h}_{2}\end{matrix} ] ;$$
establishing the laser-scanning reference coordinate system O-X″Y″Z″ with the center of the mirror as origin O, wherein a Y″-axis of the laser-scanning reference coordinate system O-X″Y″Z″ is a flight direction; a Z″-axis of the laser-scanning reference coordinate system O-X″Y″Z″ is perpendicular to the flight carrier, and points upward; and an X″-axis of the laser-scanning reference coordinate system O-X″Y″Z″, the Y″-axis and the Z″-axis form a right-handed spatial rectangular coordinate system;
when the rotation angle of the stepping motor of the hollow load-bearing rotary platform is 0°, the Y-axis of the laser-scanning coordinate system O-XYZ points to the flight direction, that is, the laser-scanning coordinate system O-XYZ and the laser-scanning reference coordinate system O-X″Y″Z″ are co-directional; when the stepping motor of the hollow load-bearing rotary platform rotates clockwise, the stepping motor drives the airborne bathymetric LiDAR unit to rotate clockwise with the center of the mirror as an origin, that is, the laser-scanning coordinate system O-XYZ rotates clockwise with the origin O around the Y-axis;
wherein the laser-scanning reference coordinate system and the laser-scanning coordinate system has a relationship as follows:
$$[ \begin{matrix}{x}^{″} \\ {y}^{″} \\ {z}^{″}\end{matrix} ] = {R}_{y} ( τ ) \cdot [ \begin{matrix}x \\ y \\ z\end{matrix} ] = [ \begin{matrix}cos τ & 0 & sin τ \\ 0 & 1 & 0 \\ - s in τ & 0 & cos τ\end{matrix} ] \cdot [ \begin{matrix}x \\ y \\ z\end{matrix} ] ;$$
wherein t represents the rotation angle of the stepping motor of the hollow load-bearing rotary platform;
according to the converting relationship, when the rotation angle of the stepping motor of the hollow load-bearing rotary platform is t, calculating a three-dimensional coordinate of an incidence point S on the water surface of the laser beam in the laser-scanning coordinate system through a formula as follows:
$$[ \begin{matrix}{x}_{S}^{″} \\ {y}_{S}^{″} \\ {z}_{S}^{″}\end{matrix} ] = {R}_{y} ( τ ) \cdot [ \begin{matrix}H tan {φ}_{x} \\ H tan {φ}_{y} \\ - {h}_{1}\end{matrix} ] ;$$
and calculating the incidence point F of the laser beam at the water bottom in the laser-scanning coordinate system through a formula as follows:
$$[ \begin{matrix}{x}_{F}^{″} \\ {y}_{F}^{″} \\ {z}_{F}^{″}\end{matrix} ] = {R}_{y} ( τ ) \cdot [ \begin{matrix}( {d}_{1} sin φ + {d}_{2} sin {φ}^{′} ) cos Ψ \\ ( {d}_{1} sin φ + {d}_{2} sin {φ}^{′} ) sin Ψ \\ - {h}_{1} - {h}_{2}\end{matrix} ] .$$
